(19) United States
(12) Patent Application Publication
(10) Pub. No.: US 2010/0104031 A1
(43) Pub. Date: Apr. 29, 2010

(54) SYSTEM FOR ELECTRICAL POWER SUPPLY AND FOR TRANSMITTING DATA WITHOUT ELECTRICAL CONTACT

(75) Inventor: Gilles Lacour, Belley (FR)

Correspondence Address: LERNER, DAVID, LITTENBERG,;KRUMHOLZ & MENTLIK, 600 SOUTH AVENUE WEST, WESTFIELD, NJ, 07090, US

(73) Assignee: DELACHAUX S.A., Gennevilliers (FR)

(21) Appl. No.: 12/532,900

(22) PCT Filed: Mar. 10, 2008
(86) PCT No.: PCT/EP2008/052827

§ 371 Date: Sep. 24, 2009

(30) Foreign Application Priority Data
Mar. 27, 2007 (FR) 0754056

(51) Int. Cl. H04B 3/54

(52) U.S. Cl. 375/258

(57) ABSTRACT

The invention relates to an assembly comprising a power transmitter (E) and a power receiver (R) respectively comprising a primary coil (11) and a secondary coil (22), in which the transmitter and the receiver are of the electromagnetic induction type and allow on the one hand the powering without electrical contact of the receiver by the transmitter, and on the other hand a bidirectional communication without electrical contact between the transmitter and the receiver.

This invention relates in general to contact-free electrical power supply and contact-free data transmission systems.

### PRIOR ART

Contact-free power supply and transmission systems enabling a power transmitting device to be coupled to a power receiving device including means for collecting data supplied by various sensors provided in the power receiving device are already known.

Conventionally, such a power receiving device is not self-contained with regard to its electrical power supply.

The power transmitting device is capable of being coupled to the power receiving device by magnetic coupling between a so-called primary winding of the power transmitting device and a so-called secondary winding of the power receiving device, without electrical contact, so as to supply power to the power receiving device and assign it a certain amount of data, which includes in particular instructions to which the power receiving device responds by transmitting data supplied by its sensors.

Conventionally, the transmission of data between the power transmitting device and the power receiving device to which it is coupled is performed according to a technique similar to carrier currents, i.e. a modulation, at a frequency substantially greater than the frequency of the alternating current generating the magnetic flux of the primary winding to the secondary winding, is superimposed on this current so as to carry signals between the two.

This known technique has the disadvantage of requiring specific modulation/demodulation circuits, which are electrical energy consumers, while the available energy of the power transmitting device is limited and must satisfy the electrical energy requirements of its circuits and circuits of the power receiving device to which it is capable of being coupled.

Moreover, modulation techniques, even if they enable the data rate to be increased, may be fragile and subject to disturbances.

For example, document US 2005/063488 describes a system for contact-free power supply and transmission between a transmitter and a receiver in which the signal from the transmitter is frequency-modulated so as to transmit data.

More specifically, the transmitter uses a frequency shift modulation method (FSK for “frequency shift keying”) to transfer data to the receiving device.

This technique of frequency modulation of the signal from the transmitter makes it difficult to synchronize the receiver with the transmitter and therefore makes data transmission difficult.

Moreover, this technique requires the presence of a modulation/demodulation circuit in the transmitter and the receiver, further increasing the complexity of the system, and consumes energy.

In particular, the receiver of US 2005/063488 includes a multi-phase demodulator capable of supplying a data flow and a clock signal from the signal produced by the transmitting device.

### SUMMARY OF THE INVENTION

This invention aims to overcome the limitations of the prior art in the field of contact-free electrical power supply and data transmission, and to propose a new system that is simple, robust and energy-efficient.

To this end, we propose, according to first aspect of the invention, a contact-free power supply and contact-free data transmission system including a transmitter having an electrical energy source and a receiver that is not self-contained with regard to its electrical power supply, in which the transmitter and the receiver respectively include a primary winding and a secondary winding capable of being in a magnetic flux transfer relationship, and the transmitter includes a circuit for applying, on the primary winding, a low-frequency alternating power supply current so as to produce, on the secondary winding, a current used for the electrical power supply of the receiver, and the transmitter and receiver have data transmission circuits connected to the primary and secondary windings, and in which system the data transmission circuit on the transmitter side is capable of selectively directly modifying the waveform of said alternating power supply current, and the data transmission circuit on the receiver side is capable of detecting these waveform modifications so as to respectively transmit, from the transmitter to the receiver, data of different values corresponding to the different waveforms, in which the frequency of the alternating power supply current is constant.

As explained above, for the transmission of data between the transmitter and the receiver, the systems of the prior art superimpose a carrier current on the power supply current.

However, for the transmission of data between the transmitter and the receiver, the system according to the invention proposes directly modifying the form of the power supply current, without changing its period or frequency. This enables a power transfer to the receiver of which the efficacy remains optimal at any time, and enables particularly simple and reliable synchronization between the transmitter and receiver.

Owing to the waveform modulation combined with high-quality synchronization, the system does not require specific modulation/demodulation circuits for the data transmission, which increase production costs and use electrical energy.

According to a second aspect of the invention, a transmitting device intended to ensure a contact-free power supply of a receiving device that is not self-contained with regard to its electrical power supply, and to transmit data thereto, including a primary winding intended to be in a magnetic flux transfer relationship with a secondary winding of the receiving device, and a circuit for applying, on the primary winding, a low-frequency alternating power supply current, as well as a data transmission circuit connected to the primary winding, in which device the data transmission circuit is capable of selectively directly modifying the waveform of said alternating power supply current, so as to selectively transmit data of different values corresponding to the different waveforms.

A third aspect of the invention proposes the application of a transmitting device as described above in an underwater robot intended to cooperate with underwater geophysical data collection equipment.

A fourth aspect of the invention proposes a receiving device that is not self-contained with regard to its electrical power supply and intended to be supplied contact-free by a transmitting device, to transmit data thereto and to receive data from same, including a secondary winding intended to be in a magnetic flux transfer relationship with a primary winding of the transmitting device, a circuit for supplying power to the device from a low-frequency alternating current circulating in the secondary winding, and a data transmission circuit capable of detecting modifications in the waveform of the alternating current itself, so as to respectively receive data of different values corresponding to the different waveforms.

A fifth aspect of the invention proposes underwater geophysical data collection equipment, in which the underwater equipment includes a receiving/transmitting device as described above.

A sixth aspect of the invention proposes a system for contact-free electrical power supply and contact-free data transmission between a stationary structure and a rotating element of a machine, which system includes a transmitting device as described above on the stationary structure and a receiving device as described above on the rotating element, and the primary winding and the secondary winding are cylindrical and arranged on around the other according to the axis of rotation of the rotating element.

### DESCRIPTION OF THE FIGURES

Other features, objectives and advantages of this invention will become clearer from the following description, which is provided purely for illustrative and non-limiting purposes, and which should be read in reference to the appended drawings, in which:

FIG. 1 is a diagram of an inductive connector,

FIG. 2 is a perspective view of a winding of the inductive connector,

FIG. 3 is a diagram of an example of an application of the inductive connector,

FIG. 4 is a circuit diagram showing an electronic board of a power transmitter,

FIG. 5 is a circuit diagram showing an electronic board of a power receiver,

FIG. 6 shows switch control signals controlled by a control unit of the power transmitter when no data is transmitted from the power transmitter to the power receiver,

FIG. 7 shows control signals of switches controlled by the control unit when data is transmitted from the power transmitter to the power receiver,

FIG. 8 shows an example for the calculation of a cyclic ratio at the receiver level.

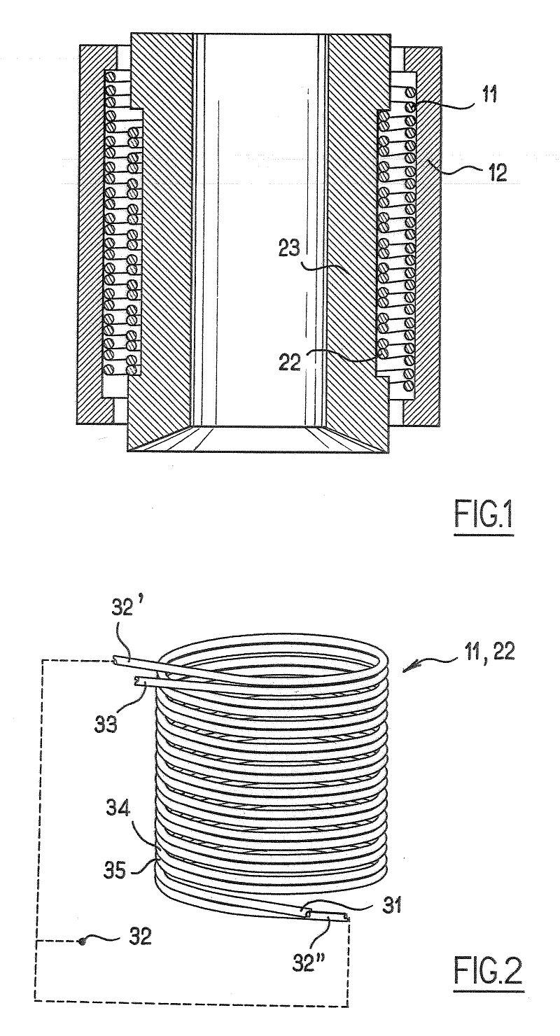

### DESCRIPTION OF THE INVENTION

### General Principle

FIG. 1 shows an inductive connector intended to be used in an electrical power supply and data transmission system including a power transmitting device and a power receiver ((hereinafter called “transmitter” and “receiver”).

The connector is of the electromagnetic induction type and enables electrical contact-free transmission:
of power from the transmitter to the receiver in order to supply power to the receiver, and
of data between the transmitter and the receiver.

The electrical contact-free data transmission between the transmitter and the receiver is two-way, i.e. data can be transmitted from the transmitter to the receiver or from the receiver to the transmitter.

This two-way communication is alternating two-way communication.

In the context of this invention, by “alternating two-way communication”, we mean communication that enables the data to be routed in both directions, but in an alternating manner (i.e. “half-duplex” communication).

More specifically, in this alternating two-way communication, the transmitted data is binary data. The alternating two-way communication is performed bit-by-bit.

Advantageously, the connector can be used in a system in which the transmitter and the receiver have at least one degree of freedom between them.

The inductive connector can be:
a hookup-type electrical connection system in which the relative movement between the two devices is axial,
a collector-type electrical transmission system in which the relative movement between the two devices is a rotation,
a system in which the two movements are combined.

The connector includes a primary winding 11 and a secondary winding 22 arranged respectively on the transmitter and the receiver.

In the embodiment shown in FIG. 1, the primary winding 11 is wound inside a sheath 12 and is connected to the transmitter.

The secondary winding 22 is wound around a drum 23. The secondary winding is connected to the receiver.

In the embodiment shown in FIG. 1, the primary and secondary windings 11, 22 are intended to fit one in the other. More specifically, the secondary winding 22 is intended to go inside the primary winding 11.

In another embodiment not shown, it is the primary winding that is intended to go inside the secondary winding. In this case, the primary winding is wound around the core and the secondary winding is wound inside the sleeve.

Obviously, other magnetic flux transfer relationships between the primary winding and the secondary winding can be envisaged (flat-plate-type primary and secondary windings arranged face-to-face and parallel to one another, or curved-plate-type primary and secondary windings so as to obtain cylinders of different diameters capable of being arranged one in the other, etc.).

Thus, the inductive connector can be adapted to different systems according to the use.

### Winding

The primary and secondary windings 11, 22 are designed as described below.

The primary and secondary windings 11, 22 comprise different numbers of turns according to the primary and secondary voltages.

In one embodiment, the secondary winding 22 is shorter in the axial direction than the primary winding 11.

In the embodiment shown in FIG. 1, the primary and secondary windings extend according to two coaxial cylinders of different diameters.

Each winding 11, 22 includes two identical parallel conductors.

In particular, each winding 11, 22 includes two electrical wire windings 34, 35 each comprising two ends 31, 32′, 32″, 33.

For each winding 11, 22, the two windings 34, 35 are concentrically interlaced.

For each winding 11, 22, an end 32′ of one 34 of the windings 34, 35 is connected to an end 32″ of the other 35 of the windings 34, 35.

These ends 32′, 32″ are connected and form a mid-point 32 of the winding 11, 22.

Thus, the primary and secondary windings 11, 22 are three connection point windings 31, 32, 33 with the mid-point 32.

The three connection points 31, 32, 33 of the primary winding 11 are connected to an electronic board 13 of the transmitter, which will be described below.

The three connection points 31, 32, 33 of the secondary winding 22 are connected to the electronic board 24 of the receiver, which will be described below.

The free ends 31, 33 of the two windings 34, 35 have a phase opposition potential when an alternating current passes through winding.

Preferably, the frequency of the alternating current is between 1 kHz and 500 kHz.

### Description of an Embodiment

The inductive connector described above can be used in various applications requiring an electrical contact-free power supply of a power receiver R by a power transmitter E, and contact-free data transmission between the transmitter E and the power receiver R.

The fact that the power supply and the two-way communication are contact-free enables the inductive connector to be adapted to a large number of applications.

In particular, the inductive connector described above can be used with a stationary element and an element that is mobile with respect to the stationary element.

In this case, the mobile element can be either the power transmitter or the power receiver.

The inductive connector can also be used with two elements that are mobile with respect to one another.

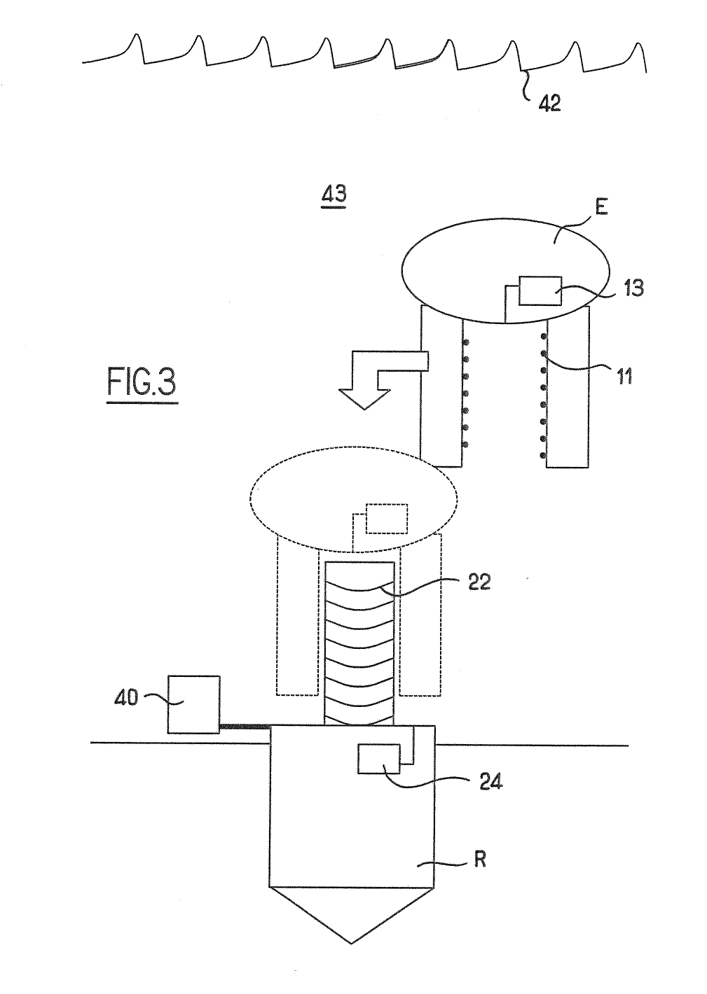

In reference to FIG. 3, we will now provide an example of an application in which the connector described above can be used.

In this application, the transmitter E is a mobile element including en electrical energy source (not shown) for the power supply of the receiver R.

The receiver R is a stationary element that is not self-contained with regard to its power supply. Advantageously, the receiver R cannot include energy storage means (such as a battery), and be solely and exclusively powered by the transmitter E. The receiver R includes sensors 40 for measuring data to be transmitted to the transmitter E.

More specifically, in this application, the transmitter E is a marine robot, and the receiver R is a pile sunken into the seabed 41. The sensors 40 of the receiver R enable marine seismic data to be measured.

The pile is intended to rest on the seabed for a number of years (for example 10 to 15 years) and is suitable for use at great depths (for example 2000 meters below sea level 42).

The robot is intended to be positioned on the pile, for example for one month, in order to carry out a marine seismic data measurement run.

The primary and secondary windings 11, 22 are protected from corrosion and aging. In particular, the turns of the primary and secondary windings 11, 22 can include an unalterable thermoplastic coating.

The mode of operation of such underwater geophysical data collection equipment is as follows.

The robot (transmitter E), including the primary winding 11, moves in the sea 43.

When the robot (transmitter E) is near the pile (receiver R), it caps the pile so that the secondary winding 22 penetrates the primary winding 11.

Once the robot (transmitter E) is positioned, the magnetic flux emitted by the primary winding 11 is received by the secondary winding 22. This magnetic flux enables electronic circuits of the pile (receiver R) to be supplied with power.

The robot (transmitter E) sends the pile (receiver R) a microprogram (or just parameters) for measuring the marine seismic data.

The pile measures the seismic data by using its sensors 40. Once the seismic data has been measured, the pile (receiver R) sends it to the robot (transmitter E), which stores it in a memory (not shown), or sends it to the outside using auxiliary means (for example, a radiofrequency antenna).

Thus, the primary and secondary windings 11, 22 enable both electrical contact-free power supply of the pile by the robot and electrical contact-free two-way communication between the robot and the pile.

As mentioned above, the flux transfer relationship between the robot and the pile can be of a type other than the nesting of the secondary winding in the primary winding, for example by flat plates arranged face-to-face and parallel to one another, or curved plate-type primary and secondary windings so as to obtain cylinders with different diameters capable of being arranged one in the other.

### Electronic Board of the Transmitter

We will now describe in greater detail an electrical contact-free mode of communication and power supply between the transmitter and the receiver.

The transmitter includes:
a power supply circuit for applying, on the primary winding, a low-frequency alternating power supply current,
a data transmission circuit connected to the primary winding.

These circuits are arranged on an electronic board of which the various elements will be described in greater detail below.

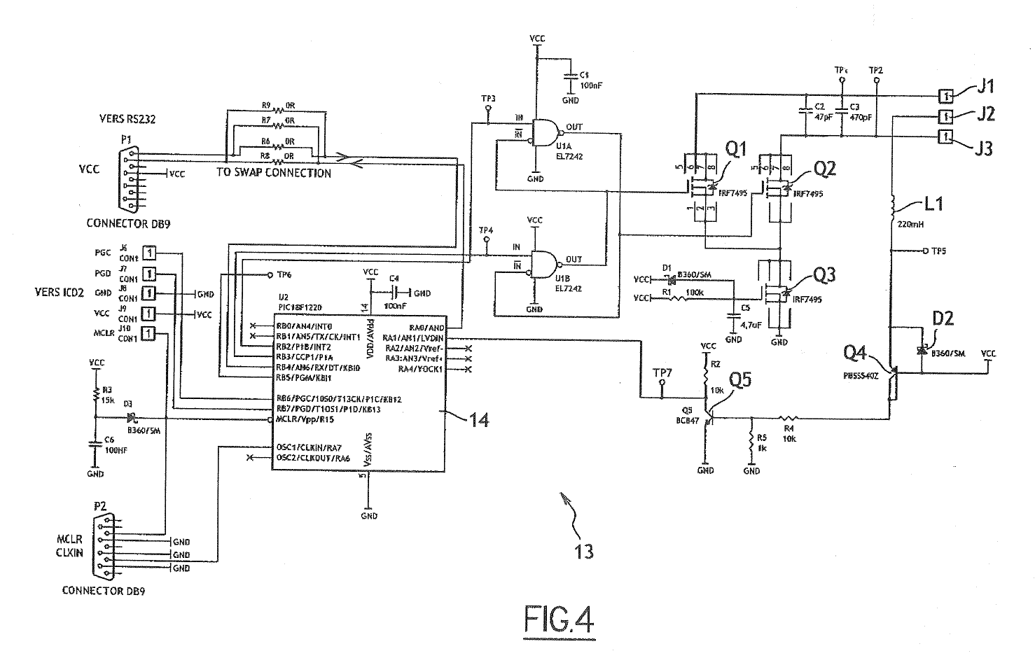

FIG. 4 shows the electronic board 13 of the transmitter E.

The diagram of the electronic board 13 of the transmitter shows first, second and third connection points J1, J2, J3 intended to be connected to the three connection points 31, 32, 33 of the primary winding 11.

The mid-point 32 of the primary winding 11 is connected to the second connection point J2. The two free ends 31, 33 of the primary winding 11 are connected to the first and third connection points J1, J3.

The circuit for applying, on the primary winding, an alternating current includes first and second switches Q1, Q2 controlled by a control unit 14. In the embodiment shown in FIG. 4, the control unit 14 is a microcontroller.

The first and second controlled switches Q1, Q2 enable direct voltage to be converted to alternating voltage (and therefore a direct current to be converted to an alternating current). In particular, the switching of the first and second controlled switches Q1, Q2 enables the low-frequency alternating power supply current to be generated.

The frequency of the alternating power supply current is preferably between 1 kHz and 500 kHz.

The primary winding is supplied with power through a coil L1 connected in J2 at the mid-point 32 of the primary winding 11.

The primary winding 11 forms a resonant circuit turned to the frequency of the low-frequency alternating current by capacitors C2, C3 of the electronic board 13. The capacitances (in farads) of these capacitors are chosen according to the inductance (in henrys) of the primary winding 11.

The oscillation at mid-frequency (a few kilohertz to a few hundred kilohertz) is maintained by the first and second controlled switches Q1, Q2.

A third controlled switch Q3 open (i.e. off) on startup protects the first and second controlled switches Q1, Q2 from short-circuits during power-on.

To generate the alternating power supply current in the primary winding, the first and second switches are controlled at a fixed frequency by the control unit 14, optionally through pilots U1A, U1B, for example when the first and second controlled switches Q1, Q2 are MOS or IGBT transistors.

In particular, the first and second switches are controlled by slot signals sent by the control unit to control inputs of the controlled switches. These slot signals are offset with respect to one another (phase-shifted), as shown in FIG. 6, which shows the control signals of the control unit.

When the control unit 14 controls the blocking 50 of the second controlled switch Q2 (off state), the control unit 14 controls, after a “short” time lapse 52 (for example equal to 0.2 μs), the conduction 36 of the first switch Q1 (on state). When the control unit 14 controls the blocking 30 of the first switch Q1, the control unit 14 controls, after a short time lapse (typically equal to 0.2 μs), the conduction 51 of the second switch Q2.

In this way, the first and second controlled switches enable the oscillation, in the primary winding 11, of the alternating power supply circuit to be maintained.

It is noted that the “short” time lapse 52 between the control for blocking one of the controlled switches Q1, Q2 and the control for conduction of the other of the switches Q1, Q2 enables the first and second controlled switches Q1, Q2 to be prevented from being on at the same time, which could lead to deterioration of the transmitter circuits.

In the embodiment shown in FIG. 4, to send data to the receiver R, the control unit 14 of the transmitter E causes the conduction times 31, 51 of the first and second controlled switches Q1, Q2 to vary.

This modified cycle generates data complementary to that corresponding to a symmetrical oscillation.

Advantageously, the data is transmitted in binary mode.

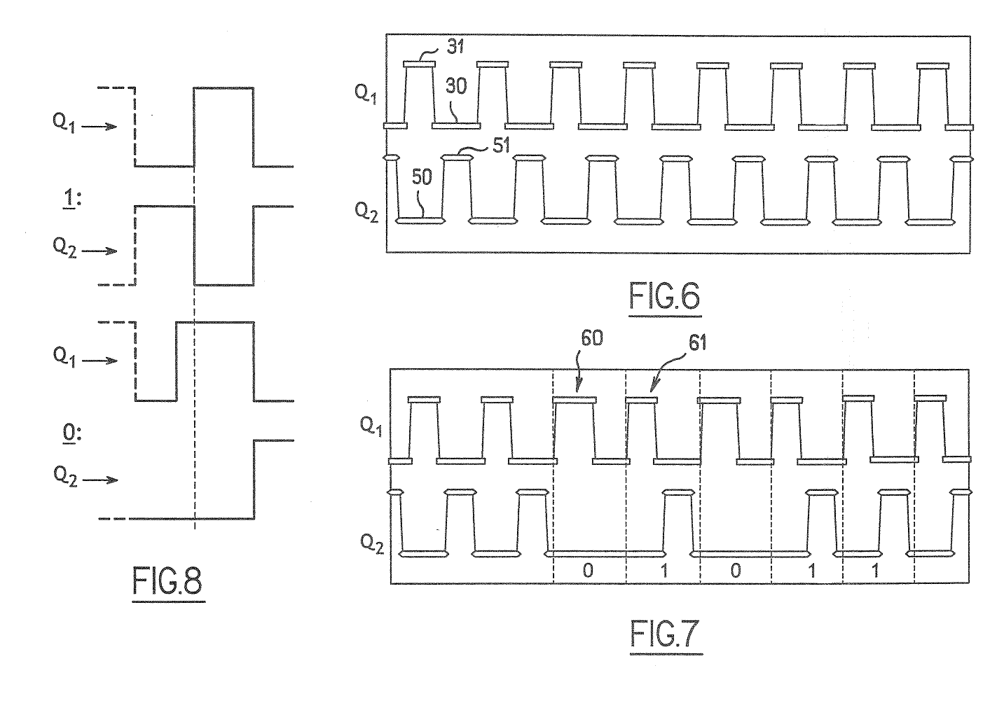

As shown in FIG. 7, to transmit a first data value 61 (in the example, a “1”), the control unit 14 sends slots to the control inputs of the first and second switches.

The slots on the first and second switches are offset from one another so that the high level of the slot applied to the first switch Q1 is in the time interval of the low level of the slot applied to the second switch Q2, and the high level of the slot applied to the second switch Q2 is in the time interval of the low level of the slot applied to the first switch Q1.

To transmit a second data value 60 (in the example, a “0”), the control unit 14 sends a slot to the first controlled switch Q1 and not to the second controlled switch Q2.

The slot applied to one of the switches in order to transmit the second data value can have a duration different from half of the resonance period of the tuned circuit including the primary winding. For example, the duration of this slot can be greater than half of the resonance period.

According to the embodiment, the data transmitted is 8-bit or 16-bit data. Of course, other embodiments can be envisaged in which the transmitted data includes N bits (in which N is an integer, preferably a multiple of eight).

In the embodiment shown in FIG. 7, the conduction time of the first controlled switch Q1 is extended during transmission of the second value.

In particular, during transmission of the second value, the end edge 37 of the slot is delayed with respect to the time of the end edge 38 of a slot applied to the first switch Q1 controlled to transmit the first data value.

Thus, to transmit a data item from the transmitter to the receiver, the data transmission circuit of the transmitter is capable of selectively directly modifying the waveform of the alternating power supply current.

According to an alternative, the data transmission circuit of the transmitter is capable of modifying the waveform of the alternating power supply current only on an alternation of the alternating current.

In the context of this invention, by “alternation”, we mean one or the other of the half-periods of the alternating power supply current, during which the power supply current does not change directions.

Advantageously, the transmitter (and the receiver) can be configured so that, during transmission of data from the transmitter to the receiver, an alternation not including the data value (so-called modulation-free or pure alternation) is used between two signals including a data value. This enables frequency drifts to be avoided between the transmitter and receiver and thus increases the reliability of the system.

The second connection point J2 is connected to means enabling:
the power supply of the primary winding 11, and
the detection and receiving of a signal transmitted by the power receiver.

These means include a coil L1 and a fourth transistor Q4.

The power supply of the primary winding 11 is provided through the coil KL1 and a device for detecting the current in the coil L1 comprising the fourth transistor Q4 and a diode D2.

Depending on the direction of the current in the coil L1, the fourth transistor Q4 conducts or is blocked. Thus, the current direction reversals in the coil L1 are detected by the fourth controlled switch Q4.

This produces a binary signal formed (by a fifth transistor Q5) so as to be received by the control unit 14, which stores said binary signal or sends it to an external device.

The control unit 14 exchanges serial data with the outside by RX and TX lines. These communications are “half duplex” communications.

### Electronic Board of the Receiver

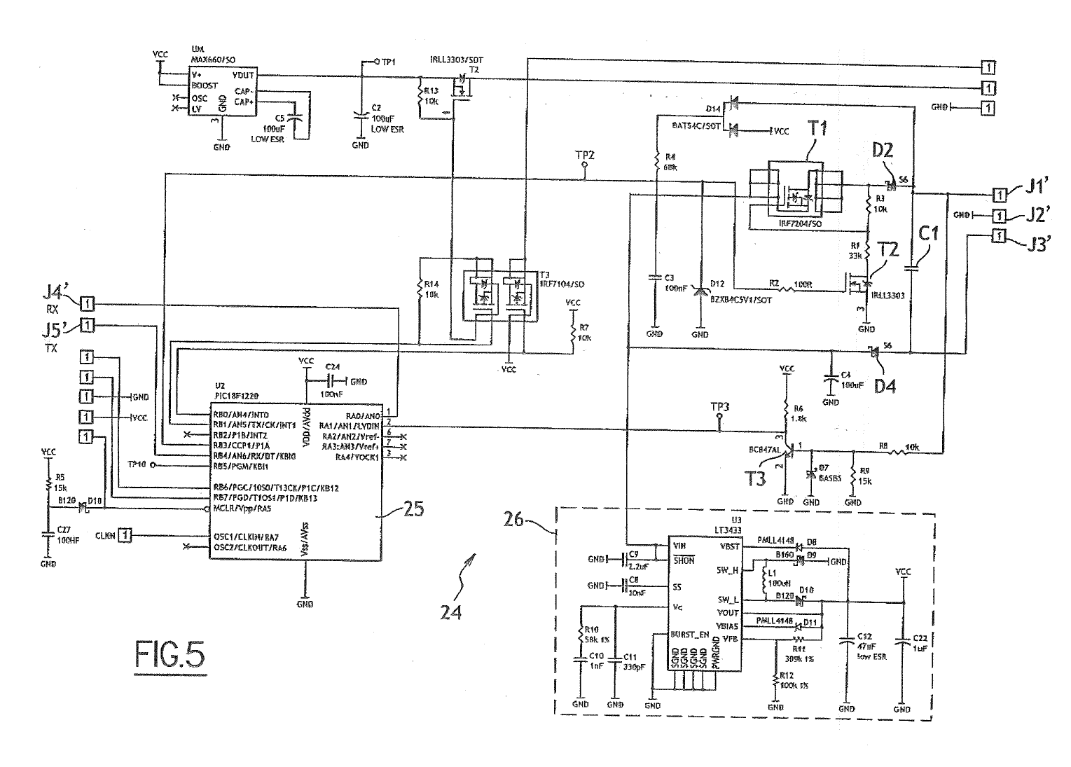

FIG. 5 shows the electronic board 24 of the secondary connector 2 of the receiver R.

The circuit diagram of the electronic board 24 of the receiver shows first, second and third connection points J1′, J2′, J3′ intended to be connected to the three connection points 31, 32, 33 of the secondary winding 22.

The mid-point 32 of the secondary winding 22 is connected to the second connection point J2′. This second connection point J2′ is connected to a reference potential (the ground).

The two free ends 31, 33 of the secondary winding are connected to the first and third connection points J1′ and J3′.

The signal between the first and third connection points J1′, J3′ can be filtered by a capacitor C1. The capacitance of this capacitor C1 is chosen (small enough) so as to avoid creating a resonant circuit with the secondary winding 22.

Thus, the secondary winding 22 is not turned at the frequency of the alternating power supply current. This makes it possible to find “defects” in the secondary winding, or more specifically waveform modifications generated by the transmitter at the level of the receiver. For example, in the case of an alternating sinusoidal waveform power supply circuit, the fact that the secondary winding is not tuned at the frequency of the alternating current makes it possible to find distortions in the sinusoidal waveform at the level of the receiver.

The third connection point J3′ is connected to means for supplying power to the receiver.

The means for supplying power to the receiver include a diode D4 and a regulator 26.

The alternating voltage at the end of the secondary winding 22 connected to the third connection point J3′ is rectified by the diode D4 in order to produce direct voltage. This direct voltage is received by the regulator 26.

The regulator 26 returns the voltage necessary for the power supply of a control unit 26 of the electronic board 24 of the receiver. In the embodiment shown in FIG. 5, the control unit 26 is a microcontroller.

The first connection point J1′ is connected to:
means for transmitting data to the transmitter E,
means for receiving data from the transmitter E.

The means for transmitting data to the transmitter include a first switch T1 controlled by the control unit 25.

The alternating voltage at the end of the secondary winding 22 connected to the first connection point J1′ is rectified by a bridge rectifier. In the embodiment shown in FIG. 5, the bridge rectifier includes a diode D2.

The control unit 25 controls the conduction of the first controlled switch T1 powering on by means of a second controlled switch T2.

The control unit 25 is connected to the sensors 40 by fourth and fifth connection points J4′, J5′ for receiving and transmitting signals to the sensors 40.

When the control unit 25 receives measurement data from one of the sensors 40 connected to the fourth connection point J4′, it controls the blocking of the first controlled switch T1 in order to interrupt the passage of the current coming from the secondary winding 22.

The blocking of the first controlled switch T1 modifies the impedance at the terminals of the secondary winding 22.

At the transmitter level, the modification of impedance at the terminals of the secondary winding 22 causes current variations in the circuit of the transmitter (reversal of the direction of the current in the coil L1 of the transmitter circuit). The transmitter, which has detected the transmission of data by the receiver, does not transmit any more data and provides the primary winding with an alternating power supply current in which the waveform is not modified (i.e. an alternating stable power supply current).

The fourth switch Q4 of the transmitter changes states (on or off) according to the direction of the current in the coil L1. This fourth controlled switch Q4 thus produces a binary signal corresponding to the data values transmitted by the receiver. This binary signal is formed (by the fifth controlled switch Q5) and sent to the control unit 14 of the transmitter, which stores it or sends it to the outside.

This is how data is transmitted from the receiver to the transmitter.

Advantageously, the receiver can be configured so that, during transmission of data from the receiver to the transmitter, N alternations not including a data value (i.e. N pure alternations) are used between two signals including a data value. This enables the reliability of the system to be increased.

Preferably, N will be between two and four.

A third controlled switch T3 is connected to the first connection point J1′. The third controlled switch T3 is used to synchronize the control unit 25 of the receiver with the control unit 14 of the transmitter and to receive data from the transmitter.

The fact that the period of the signal from the transmitter is constant enables a synchronized clock to be provided between the transmitter and receiver.

The third controlled switch T3 conducts or is blocked according to the direction of the current in the secondary winding 22, thereby produces a binary rectangular single that is received by the control unit 25.

When the alternating power supply current of the primary winding 11 is stable (i.e. the form of the alternating power supply signal is not modified by the transmitter in order to send a data value), the third controlled switch produces a (binary) stable rectangular signal received by the control unit. This stable rectangular signal enables the control unit of the receiver to be synchronized with the control unit of the transmitter. Thus, a synchronized clock between the transmitting and receiving devices is obtained.

The third controlled switch T3 is also used to receive data from the transmitter.

The distortion of the form of ht alternating power supply current caused by the transmission of data by the transmitter is detected by the third controlled switch T3.

This distortion causes a variation in the rectangular signal from the third controlled switch T3, sent to the control unit.

To determine the value of the data sent by the transmitter, the cyclic ratio of the rectangular signals from the third controlled switch T3 is calculated.

In reference to FIG. 8, in the context of this invention, by “cyclic ratio”, we mean the ratio between:
the duration 70, 71, 72+73 during which the rectangular signal from the third controlled switch T3 is at the high level over a period P, and
the duration 74 of this same period P.

The period P corresponds to the time interval after which the signal from the third controlled switch T3 takes the same series of values when the form of the alternating power supply current is not modified by the transmitter.

The duration during which the rectangular signal from the third controlled switch T3 is at the high level can correspond:
to a single duration 71 over a period and corresponding to a single high level over said period,
to the sum of a plurality of durations 72, 73 corresponding to a plurality of high levels over said period.

The cyclic ratio is representative of the value (“0” or “1”) of the data transmitted by the transmitter.

This is how data is transmitted from the transmitter to the receiver.

The connector described above can be adapted to numerous applications, such as, for example, the stress measurement in a reactor blade, or any other application in which a first element is to be powered by a second element, and two-way communication is to be established between these two elements, in which said elements can be:
a stationary element and an element that is mobile with respect to the stationary element,
or two mobile elements.

### Key to the Figures

Figures and 5

| | |
|---|---|
| VERS | TO |

1. Contact-free power supply and contact-free data transmission system including a transmitter having an electrical energy source and a receiver that is not self-contained with regard to its electrical power supply, in which the transmitter and the receiver respectively include a primary winding and a secondary winding capable of being in a magnetic flux transfer relationship, and the transmitter includes a circuit for applying, on the primary winding, a low-frequency alternating power supply current so as to produce, on the secondary winding, a current used for the electrical power supply of the receiver, and the transmitter and receiver have data transmission circuits connected to the primary and secondary windings, which system is wherein the data transmission circuit on the transmitter side is capable of selectively directly modifying the waveform of said alternating power supply current, and in that the data transmission circuit on the receiver side is capable of detecting these waveform modifications so as to respectively transmit, from the transmitter to the receiver, data of different values corresponding to the different waveforms, in which the frequency of the alternating power supply current is constant.

2. System according to claim 1 wherein the waveform modification is applied only on an alternation of the current.

3. System according to claim 2 wherein data transmission circuit on the transmitter side is capable of modifying the symmetry of the two half-waves.

4. System according to claim 3 wherein the primary winding is tuned to the frequency of the low-frequency alternating current, and in that the data transmission circuit includes at least one controlled switch capable of modifying the excitation of the tuned circuit including the primary winding.

5. System according to claim 4 wherein the data transmission circuit includes a pair of switches controlled by a control unit, and in that the control unit is capable of providing, at control inputs of the controlled switches, slots offset from one another so that the high level of one of the slots is in the time interval of the low level of the other, so as to transmit a first data value, or a slot on one of the switches and no slot on the other switch so as to transmit a second data value.

6. System according to claim 5 wherein the slot applied to one of the switches in order to transmit the second data value has a value different from half of the resonance period of the tuned circuit including the primary winding.

7. System according to claim 6 wherein the duration of said slot is greater than half of said resonance period.

8. System according to claim 7 wherein the time of the end edge of said slot is delayed with respect to the time of the end edge of a slot applied to the same controlled switch in order to transmit the first data value.

9. System according to claim 1 wherein the transmission circuit on the receiver side is capable of clipping voltage at the terminals of the secondary winding so as to produce rectangular signals representative of values of the data transmitted by the transmitter.

10. System according to claim 9 wherein the cyclic ratio of the rectangular signals is representative of the value of each data item.

11. System according to claim 1 wherein the data transmission circuit on the receiver side is capable of selectively modifying the impedance at the terminals of the secondary winding, and in that the data transmission circuit on the transmitter side is capable of detecting current variations in the circuit of the primary winding.

12. System according to claim 11 wherein the data transmission circuit on the receiver side includes a switch capable of being short-circuited downstream of a bridge rectifier connected to the secondary winding, so as to carry out said impedance modification.

13. System according to claim 11 wherein said impedance modification is carried out only on an alternation of the current.

14. System according to claim 11 wherein the data transmission circuit on the transmitter side is capable of detecting a current reversal through a coil connected to the primary winding.

15. System according to claim 14 wherein the inverted current is capable of controlling the change in state of a switch.

16. System according to claim 1 wherein the power receiver does not include a battery, and the power supply of the receiver is provided only by the current in the secondary winding.

17. System according to claim 1 wherein the primary and secondary windings extend according to two coaxial cylinders, with different diameters, one fitted inside the other.

18. System according to claim 17 wherein the primary winding is outside the secondary winding.

19. System according to claim 18 wherein the secondary winding is shorter in the axial direction than the primary winding.

20. System according to claim 1 wherein the primary and secondary windings are three-point windings with a mid-point.

21. System according to claim 1 wherein the frequency of the alternating current is between around 1 kHz and 500 kHz.

22. Transmitting device intended to ensure a contact-free power supply of a receiving device that is not self-contained with regard to its electrical power supply, and to transmit data thereto, including a primary winding intended to be in a magnetic flux transfer relationship with a secondary winding of the receiving device, and a circuit for applying, on the primary winding, a low-frequency alternating power supply current, as well as a data transmission circuit connected to the primary winding, which device is characterized in that the data transmission circuit is capable of selectively directly modifying the waveform of said alternating power supply current, so as to selectively transmit data of different values corresponding to the different waveforms.

23. Device according to claim 22 wherein the waveform modification is applied only to an alternation of the current.

24. Device according to claim 23 wherein the data transmission circuit is capable of modifying the symmetry of the two half-waves.

25. Device according to claim 24 wherein the primary winding is tuned to the frequency of the low-frequency alternating current, and in that the data transmission circuit includes at least one controlled switch capable of modifying the excitation of the tuned circuit including the primary winding.

26. Device according to claim 25 wherein the data transmission circuit includes a pair of switches controlled by a control unit, in that the control unit is capable of providing, to control inputs of the controlled switches, either slots offset from one another so that the high level of one of the slots is in the time interval of the low level of the other in order to transmit a first data value or a slot on one of the switches and not on the other switch so as to transmit a second data value.

27. Device according to claim 26 wherein the slot applied to one of the switches in order to transmit the second data value has a duration different from half the resonance period of the tuned circuit including the primary winding.

28. Device according to claim 27 wherein the duration of said slot is greater than half of said resonance period.

29. Device according to claim 28 wherein the time of the end edge of said slot is delayed with respect to the time of the end edge of a slot applied to the same controlled switch in order to transmit the first data value.

30. Device according to claim 22 wherein the data transmission circuit is capable of detecting current variations in the primary winding circuit, so as to enable the transmission of data from the receiving device to the transmitting device.

31. Device according to claim 30 wherein said impedance modification is performed only on an alternation of the current.

32. Device according to claim 30 wherein the data transmission circuit on the transmitter side is capable of detecting a current reversal through a coil connected to the primary winding.

33. Device according to claim 32 wherein the reversed current is capable of controlling the change in state of a switch.

34. Device according to claim 22 wherein the primary winding extends according to a cylinder in a sheath intended to receive the primary winding.

35. Device according to claim 22 wherein the primary winding is a three-point winding with a mid-point.

36. Device according to claim 22 wherein the frequency of the alternating current is between around 1 kHz and 500 kHz.

37. Use of a transmitting device according to claim 22 in an underwater robot intended to cooperate with underwater geophysical data collection equipment.

38. Receiving device that is not self-contained with regard to its electrical power supply and intended to be supplied contact-free by a transmitting device, to transmit data thereto and to receive data from same, including a secondary winding intended to be in a magnetic flux transfer relationship with a primary winding of the transmitting device, a circuit for supplying power to the device from a low-frequency alternating current circulating in the secondary winding, and a data transmission circuit capable of detecting modifications in the waveform of the alternating current itself, so as to respectively receive data of different values corresponding to the different waveforms.

39. Device according to claim 38 wherein the transmission circuit is capable of clipping the voltage at the terminals of the secondary winding so as to produce rectangular signals representative of the data values received.

40. Device according to claim 39 wherein the cyclic ratio of the rectangular signals is representative of the value of each data item.

41. Device according to claim 38 wherein the data transmission circuit on the receiver side is capable of selectively modifying the impedance at the terminals of the secondary winding, in order to respectively send data of different values corresponding to different impedance states intended to be detected by the transmitting device.

42. Device according to claim 41 wherein the data transmission circuit includes a switch capable of being short-circuited downstream of a bridge rectifier connected to the secondary winding, so as to carry out said impedance modification.

43. Device according to claim 41 wherein said impedance modification is carried out only on an alternation of the current.

44. Device according to claim 38 wherein the secondary winding extends according to a cylinder over a drum around which the secondary winding is intended to be placed.

45. Device according to claim 38 wherein the secondary winding is a three-point winding with a mid-point.

46. Device according to claim 38 wherein the frequency of the alternating current is between around 1 kHz and 500 kHz.

47. Underwater geophysical data collection equipment wherein it includes a receiving device according to one of claims 38 to 46.

48. System for electrical power supply and data transmission without contact between a stationary structure and a rotating element of a machine, wherein it includes a transmitting device according to one of claims 22 to 36 on the stationary structure and a receiving device according to one of claims 38 to 46 on the rotating element, in which the primary winding and the secondary winding are cylindrical and arranged one around the other according to the axis of rotation of rotating element.
